(19) United States
(12) Patent Application Publication
(10) Pub. No.: US 2017/0268730 A1
(43) Pub. Date: Sep. 21, 2017

(54) GLASS JACKETED LED LAMP

(71) Applicant: Eye Lighting International of North America, Mentor, OH (US)

(72) Inventors: Dengke Cai, Willoughby, OH (US); Paul J. Jurkovic, Painesville, OH (US); Thomas G. Salpietra, Concord Township, OH (US)

(21) Appl. No.: 15/326,456

(22) PCT Filed: Mar. 21, 2016
(86) PCT No.: PCT/US2016/023494

§ 371 Date: Jan. 13, 2017

Related U.S. Application Data
(60) Provisional application No. 62/136,427, filed on Mar. 20, 2015.
(60) Provisional application No. 62/247,628, filed on Oct. 28, 2015.
(60) Provisional application No. 62/308,170, filed on Mar. 14, 2016.

(51) Int. Cl. F21K 9/275; F21K 9/278; F21V 29/83; F21K 9/272; F21V 3/02; F21V 3/04; F21V 5/02; F21V 31/00

(52) U.S. Cl. CPC F21K 9/275; F21V 5/02; F21K 9/278; F21V 31/00; F21K 9/272; F21V 3/02; F21V 3/0418; F21V 29/83; F21Y 2115/10

(57) ABSTRACT

A glass jacketed led lamp is characterized by a prismatic LED module positioned coaxial to the axis of a cylindrical glass jacket having an inside diameter Dl, wherein the LED module comprises: a prismatic LED carrier structure having N longitudinal sides, and LEDs that are operationally mounted on at least one of the N sides; wherein: the carrier structure was formed by folding a single metal core printed circuit board (MCPCB) into a convex prismatic polyhedron; the prism cross section is an irregular and incomplete polygon such that the N sides are bounded by N+1 longitudinal fold edges, wherein a first edge and the (N+1)th edge are back edges that are spaced apart by a first separation GAP1.

### CROSS-REFERENCE TO RELATED APPLICATIONS

This application claims the benefit of U.S. Provisional Patent Application No. 62/136,427 filed Mar. 20, 2015; U.S. Provisional Patent Application No. 62/247,628 filed Oct. 28, 2015, and U.S. Provisional Patent Application No. 62/308,170 filed Mar. 14, 2016, said applications hereby incorporated in their entirety by reference herein.

### BACKGROUND OF THE INVENTION

It is desirable to provide an LED lighting source with an overall shape and/or size within the bounds of a lamp with equivalent light output (e.g., lumens) that it replaces. This is particularly difficult for higher output lamps, such as HID lamps (e.g., HPS, MH, CMH), due to the need for cooling of the LED junction. A prior art solution has been to mount LED modules on an open framework extended from the lamp base such that ambient air can circulate through cooling fins on the back of the module(s). However, this may have problems if exposed to wet, dirty, or otherwise unfavorable ambient conditions. In other cases, an enclosure may be needed to prevent physical contact. Thus enclosing the LEDs in a glass bulb/enclosure/jacket is desired, but attempts so far are generally limited to a low power due to difficulty of extracting heat from the enclosed volume, or for higher power the lamp assembly is overly complicated and expensive.

It is an object of this disclosure to replace an HID lamp with an enclosed LED light source of equivalent (high) lumen output. It may be further desirable for the LED source to be contained in a bulb (outer jacket) with an electrical connector configuration that can be retrofit into an existing fixture. This means that relatively high power LEDs must be used, and that will require new means and methods for adequately cooling the LEDs.

### BRIEF SUMMARY OF THE INVENTION

According to the invention a glass jacketed led lamp is characterized by a prismatic LED module positioned coaxial to the axis of a cylindrical glass jacket having an inside diameter D1, wherein the LED module comprises: a prismatic LED carrier structure having N longitudinal sides, and LEDs that are operationally mounted on at least one of the N sides; wherein: the carrier structure was formed by folding a single metal core printed circuit board (MCPCB) into a convex prismatic polyhedron; the prism cross section is an irregular and incomplete polygon such that the N sides are bounded by N+1 longitudinal fold edges, wherein a first edge and the (N+1)th edge are back edges that are spaced apart by a first separation GAP1; and the MCPCB board extends from at least one of the back edges inward toward a distal front side, thereby forming at least one interior wall that divides the structure into an open cavity flanked by at least one side cavity; and at least the second through the Nth edges are in thermal contact with the glass jacket. Preferably the back edges are also spaced inward from the jacket inside diameter D1 by a second separation GAP2.

According to the invention the at least one interior wall is thermally attached to a distal front side, thereby additionally heat sinking the front side.

According to the invention LEDs mounted only on one or two front sides; thereby providing directed light output with a beam spread substantially determined by the angles at the edges of the one or two front sides.

According to the invention, in an unbiased neutral state, the LED carrier edges are circumscribed by a circle of diameter D2 ′ that is greater than the jacket inside diameter D1, and the metal board is resilient with a spring bias toward the neutral state, such that the module is in a constricted state when inside the jacket, thereby biasing the fold edges into thermal contact with the jacket wall, and providing friction to hold the LED module in a predetermined longitudinal position within the jacket.

According to the invention, a wool-like porous and highly interconnected lightweight material having thermal conductivity greater than about 10 W/mK, substantially filling one or more of the center and side cavities, and thermally contacting the MCPCB walls therearound.

According to the invention, the LED carrier is a metal printed circuit board (MCPCB) comprising: a polyimide dielectric layer, and copper traces without a solder mask layer; thereby enabling MCPCB bending without surface cracking, and minimizing potential VOC emissions.

According to the invention, an AC LED driver circuit mounted on at least one carrier side that is separate from any side that is an LED mounting face

According to the invention, AC LED driver circuit mounted on at least one of the at least one interior walls.

According to the invention, a lamp base adhered over an open end of the jacket.

According to the invention, the base is plastic.

According to the invention, the base has thermal conductivity greater than 1 W/mK.

According to the invention, the LED carrier extends into thermal contact with the base.

According to the invention, the base comprises a watertight seal for the lamp wherein vent openings are sealed or covered by a methyl silicone breathable membrane or adhesive or sealant, thereby allowing egress of volatile materials while blocking liquid water.

According to the invention, a desiccant material inside the jacket.

According to the invention, one or a combination of getters for capturing volatile materials, wherein the getters are selected from a group that includes: active carbon, natural zeolite, de-aluminized zeolite, surface treated zeolite, and silica.

According to the invention, the base is at least partly made from a porous ceramic having a pores too small to allow passage of liquid water.

According to the invention, the porous ceramic is etched polycrystalline alumina. The present disclosure includes the following material:
heat extraction from LED PCB in a glass jacket (GJ), including a folded PCB support structure/heat sink.
Further development of folded PCB support structure/heat sink, and cylindrical T-bulb for glass outer jacket (GJ)
getters in GJ LED lamps (zeolite, moisture adsorbers)
metal wool heat conductive filling
unsealed (air filled) OJ with breathable plug to vent outgassed VM, and humidity adsorber.
LED driver “on board” (on the MCPCB Metal Core Printed Circuit Board) of the LED carrier
   driver on board is mounted on MCPCB walls inside the folded structure (in cavity)
plastic base/cap glued on instead of heat sealed glass (preferably clamped in fixture, not screw base) and vent hole is covered by a sticker/patch version of the silicone membrane
no jacket, put in a sealed fixture with lens for protection, attach a mounting bracket to MCPCB that conducts heat away to fixture frame/structure (e.g., Urban Act floodlight fixture that uses 50w or 75W CMH lamps, 4-6″ long, Horizontal in reflector. LEDs on two sides →270 degree beam spread without using reflector.)
refinements, more details and/or improvements
   plastic cap on both ends, so that plain cylindrical tube can be used without needing domed end
   LEDs can be applied to any or all outside surfaces of the folded MCPCB 4 directional or non-directional lighting, LEDioc with a blank side, etc.
   use this to replace HID lamps & ballasts by retrofitting in old fixtures (e.g., “shoebox”).

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different versions of an element 109 which are similar or related in some way but are separately referenced for the purpose of describing modifications to the parent element (109). Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a view of , according to the invention.

FIG. 2 . . . etc.>

### DETAILED DESCRIPTION OF THE INVENTION

The following table is a glossary of terms and definitions, particularly listing drawing reference numbers or symbols and associated names of elements, features and aspects of the invention(s) disclosed herein.

| REF. | TERMS AND DEFINITIONS |
|---|---|
| 100 | LED Module |
| 102 | LED carrier (folded MCPCB) |
| 104 | MCPCB, metal core printed circuit board |
| 106 | grooves in the MCPCB used to thin the metal on the inside of the folds |
| 108 | |
| 110 | LED (Light Emitting Diode) for mounting on a printed circuit board |
| 112 | Edge of the prismatic carrier, a fold/bend line, designated E1 to E(N + 1) in numeric order |
| | starting and ending with the “back edges”, and the prism has an N-sided irregular and |
| | incomplete polygonal cross section |
| 114 | Side of the prismatic carrier, flat face between edges, designated S1 to S(N) in numeric |
| | order starting and ending with the “back edges”. Is a “mounting face” when LEDs are |
| | operationally mounted on it. |
| 115 | mounting face, side of the LED carrier that is used to mount LEDs |
| W | Width of a side/wall/tab of the carrier, may be designated according to side, e.g., W(S1) |
| D1 | Cylindrical inside diameter of the glass jacket 210 |
| D2 | Diameter of a circle that circumscribes the carrier 102 when it is installed in the glass |
| | jacket. Preferably equal to glass jacket diameter D1 |
| D2′ | Diameter of a circle that circumscribes the carrier 102 when it is in an unbiased neutral |
| | state, e.g., after being folded but before being inserted into the glass jacket. Preferably |
| | the MCPCB is resilient with a spring bias toward the neutral state, and D2′ is greater than |
| | the jacket inside diameter D1. As a result, the module is in a constricted state when |
| | inside the jacket, thereby biasing the fold edges into thermal contact with the jacket wall, |
| | and providing friction to hold the LED module in a predetermined longitudinal position |
| | within the jacket. |
| GAP1′ | separation of the spaced-apart back edges when the carrier is in an unbiased neutral state. |
| | Preferably GAP1′ is greater than GAP1 because D2′ is greater than D2. |
| GAP1 | separation of the spaced-apart back edges, creates an opening for gas convection into or |
| | out of the interior cavity. |
| GAP2 | optional separation where the back edges are preferably spaced inward from the |
| | cylindrical diameter (D1) of the glass jacket inside surface. |
| 116 | Back edges = edges where the incomplete polygon is open to an interior cavity |
| 118 | front side(s) distal to the back edges. For an even number N of sides there are two front |
| | sides corresponding to the two back edges. Otherwise there is only one front side. |
| 120 | interior wall(s) (at least one, optionally two) extend from at least one of the back edges |
| | inward toward a distal front side. May be designated as walls I1 and I2. |
| 122 | thermal attachment tab (optional), bent to extend from the interior wall along the inside |
| | surface of the front side for thermal attachment, thereby additionally heat sinking the |
| | front side. May be designated as tabs T1 and T2. |
| 124 | interior/center cavity open at the back edges for enhanced “chimney effect” convection. |
| | The carrier structure is divided by the interior wall(s) into an open center cavity flanked |
| | by at least one side cavity. |
| 126 | side cavity, a subdivision of the interior of the LED module, typically closed relative to |
| | the back edge GAP1/GAP2. |
| 128 | thermal attachment/fastener. May be mechanical (e.g., rivet, screw), or other suitable |
| | means (e.g., weld, solder, adhesive), and may include thermal conductivity enhancement |
| | (e.g., thermal grease/paste) |
| 130 | hole for mechanical fastener |
| 132 | metal wool, a high thermal conductivity metal (e.g., aluminum or copper) in a porous but |
| | highly interconnected form, filling cavities and firmly contacting the MCPCB walls that |
| | surround it. |
| 134 | |
| 136 | dielectric coating on the LED mounting surface of the MCPCB, preferably polyimide |
| 138 | circuit traces interconnecting electric components on the MCPCB, preferably without a |
| | solder mask layer |
| 140 | LED driver circuit mounted on the MCPCB. Includes rectifier so that AC line voltage |
| | can be directly supplied to the LED module through the lamp lead wires |
| 142 | lead wires |
| 144 | fused glass seal (bulb neck fused to stem flange) |
| 146 | lamp exhaust tube |
| 148 | breathable plug/membrane, methyl silicone (2-part curing) |
| 150 | adhesive/sealant used in base, preferably breathable silicone |
| 152 | breathing/vent hole (in base) |
| 154 | lamp base (any kind) |
| 156 | plastic base/cap |
| 158 | thermally conductive plastic material in base |
| 160 | water blocking porous ceramic material used in base |
| 162 | getter in lamp for capturing volatile materials (e.g., desiccant, silica, active carbon, |
| | natural zeolites, de-aluminized zeolites (hygroscopic), surface treated zeolite) |
| 164 | electric insulator |
| TCA | thermal contact area, either direct (d) or indirect (i) contact of carrier with thermally |
| | conductive base. Indirect is through intervening glass jacket. |
| 170 | luminaire, lighting fixture |
| 171 | fixture reflector |
| 172 | fixture socket |
| 174 | metal strap or clamp used in fixture to establish thermal contact of lamp base and/or |
| | LED carrier to heat sinking body of fixture |
| 200 | Glass jacketed LED lamp |
| 210 | glass jacket, preferably a tubular “T” bulb, straight sided without a neck, optionally |
| | domed on one end. |
| C | Center axis of cylindrical glass jacket |

The invention(s) will now be described with reference to the drawings using the reference numbers and symbols listed in the above table.

The present lamp design started with a goal of designing an HID LED replacement lamp with different technical solutions including thermal management and optical optimization under the condition of keeping the traditional HID glass jacket (bulb) shape, and sealed with a gas filling and using a metal base such as a screw threaded mogul or medium base.

Fundamentally, our approach is to lower the thermal resistance between the LEDs mounted inside of a glass jacketed LED lamp, and the ambient air outside the glass jacket. The following three focuses were presented as major objectives of the early work:
Obtain higher equivalent thermal conductivity of thermally conductive gas filling.
Increase the gas convection coefficient inside the sealed glass jacket.
In addition to gas conduction/convection transferring heat from LEDs to glass jacket and from the GJ to ambient air; utilize other thermal pathways to the outside.
Heat Conducted By Gas Filling

Helium and H2 may be applied as internal conductive gas transporting heat from LED source to glass jacket. Glass jacket behaves the function to dissipate heat to outside air.

The glass jacket is a good heat sink due to its large surface area and thermal conductivity of ˜1 W/mK. Although this glass thermal conductivity is relatively low, the effective total heat transfer can be large because the glass is thin (e.g., about 1 mm) and convective heat transfer both inside and outside is magnified by the large glass jacket surface area exposed to air flow.

A thermally conductive LED carrier 102 is applied in lamp, like MCPCB 104 (Metal Core Printed Circuit Board). This is typically made of aluminum which has a high thermal conductivity to take heat away from LED junctions and spread it over large surface area of the PCB (printed circuit board, assumed in this disclosure to be made of metal=MCB). The large surface area increases the total convective heat transfer to surrounding gas filling.

The MCPCB 104 is a printed circuit board (PCB) made of metal instead of fiberglass/epoxy, and may be abbreviated as “MCB” for metal core board or metal circuit board. The MCPCB may be referenced herein by various terms including MCPCB, Metal PCB, MCB and even simply as a PCB, but all such terms should be understood as references to the same thing (the Metal Core Printed Circuit Board).

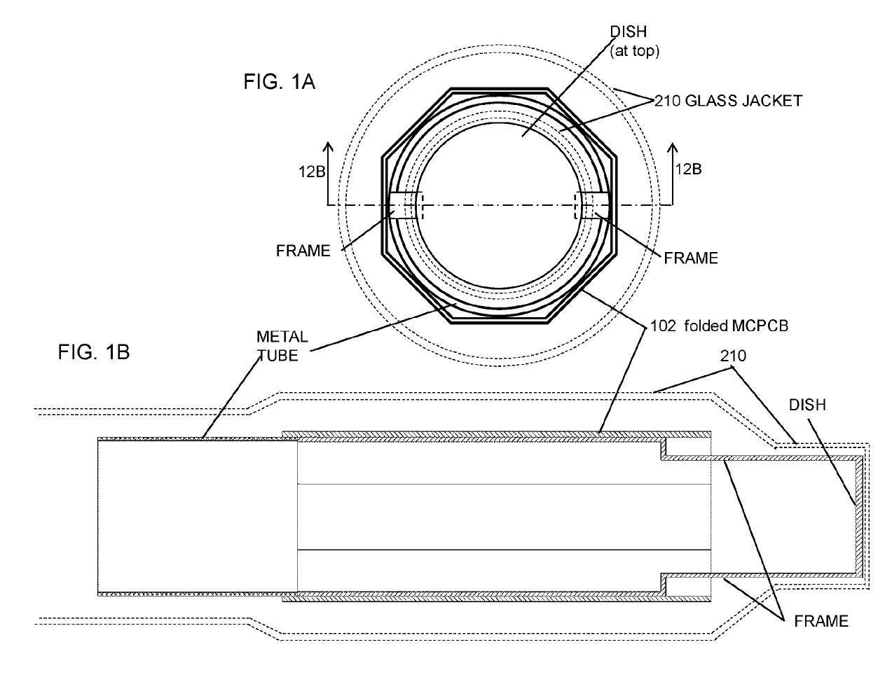

In an embodiment, electrically conductive and highly thermal conductive metals like copper, Al or tungsten or their combination are used as MCB supports and electrical leads that pass through the sealing stem to be connected with lamp base (see FIG. 1A, 1B). In this way, heat may be conducted out to the base.

Unfortunately heat created during lamp glass sealing can be conducted in to the MCB and LEDs to damage LEDs both by overheating and by causing the MCB coatings to outgas and the gases may also damage the LEDs. Furthermore, the sealing heat can be carried by gas convection. A heat shield is one of several ways that were considered in prv2 for combating this problem.

The other important factors needing to be controlled are Helium pressure and gas flowing path inside lamp, since HID replacement lamp has bigger volume glass jacket compared with regular A19 lamp, which could be applied to build an internal He flowing path including inlet/outlet under high pressure, like 5 atm. The thermal resistance through the gas obviously depends on its thermal conductivity and the magnitude of the natural convection within the bulb from helium. If with similar temperature change and difference within internal He environment, the natural convection coefficient will be greatly increased under higher pressure of Helium and related with internal glass jacket & metal grids design. By theoretical calculation, 5 atm pressure can create 20× increase on nature He convection coefficient vs. regular 1 atm. For example, double layer jacket with built in air flow path can match well LEDs and related metal grids from air dynamic flowing point of view.

To utilize higher pressure Helium inside glass lamp, it does not contribute much to He thermal conductivity increase but can definitely increase internal natural convection coefficient, and improve the He diffusion into LED encapsulation silicone and soldering material and decrease the thermal resistance in silicone and soldering layer due to its 7× higher K than air. However, it brings risks on possible gas leaking due to pressure difference between interior and exterior glass lamp, and mechanical stress added on LEDs soldering, silicone and package materials etc.
Metal Grids/Surfaces/Structures

As mentioned above, helium may be applied as thermally conductive gas or major thermal path to dissipate heat flux created from LEDs to glass jacket. The thermal resistance through the gas obviously depends on its thermal conductivity and the magnitude of the natural convection within the bulb. Due to closed environment and limited volume size of glass bulb, it is not easy to improve magnitude of the He natural convection coefficient, therefor the effective thermal conductivity of the bulb fill gas is a major path to minimize the thermal resistance between LEDs and glass jacket.

Longitudinally extending metal components such as the frame, and also tubular surfaces such as the shroud, can enhance thermal dissipation from lamp bottom to top and effectively decrease the thermal resistance, or increase the effective thermal conductivity of gas in vertical direction. They spread out the contact area and also provide a “chimney effect”.

Certainly, the goal is to utilize various internal metal surfaces inside glass jacket to effectively decrease thermal resistance between LEDs to glass jacket in different directions. It is not limited to only utilize thermally conductive metal based side supports and shroud supports shown above. For example, their shape and structure can be optimized to match with LEDs distribution/thermal source distribution to further enhance not only effective thermal conductivity of gas, but the helium convection coefficient in glass bulb, especially the area close to glass jacket, and to further decrease the thermal resistance between LEDs and glass jacket.

In addition, metal surfaces that directly contact with glass jacket internal surface will benefit by directly conducting heat from metal to glass. The contact can be mechanical contact by direct touch or with thermally conductive material in between.

### EXAMPLE

An embodiment of an LED replacement lamp for high power HID lamp is presented with reference to top and side cross-sectional views shown in FIGS. 1A and 1B respectively. This embodiment is a schematic representation of one example implementation of the inventive concepts herein disclosed, particularly showing how to effectively decrease thermal resistance to heat transfer from LEDs to glass jacket using conduction and fill gas convection.

A stem and lamp base and electrical connectors etc. would normally be at the base end (left of FIG. 1B) but is omitted to focus on the LED lamp structure relative to the glass jacket. Also, the glass jacket is illustrated in a simplified form with sharp corners and straight sides rather than the more complex, rounded profile of a typical glass jacket. The cross-section view is taken along the line 12B-12B shown in FIG. 1A.

Important features/aspects include:
Use an octagon shape folded thermally conductive PCB 102 (not limited to an octagon shape) as LED carrier with hollow center structure (or PCBs mounted on shaped metal tube with hollow center) to create effective air flow path inside bulb and increase the internal filled gas convection coefficient, and behave as metal grids/surfaces to increase effective heat flux dissipation area below heat sources (LEDs), i.e. to lower the thermal resistance created in the volume included by folded PCBs, and also to get uniform light distribution by matching well with glass jacket 210 shape because the PCB is closer to being cylindrical due to the 8 or more sided tubular shape.
Decrease the distance between folded PCB 102 to glass jacket 210 to further lower the thermal resistance through filled gas. The multi-sided PCB enables this, especially when used in straight sided cylindrical-tubular outer jacket 210.
LEDs on the PCB 102 (assumed but not illustrated) can be directly touching the glass jacket with minimum or without air gap by using additional refractive index matching compound (e.g., a liquid or paste).
A metal dish attached at top of metal frame and designed to touch as much as possible of the internal top surface of the glass jacket.

The prv3 provisional application focused on replacing a horizontal burning, tubular high wattage HID lamp, most particularly the 1000 Watt Double Ended (DE) HPS horticultural lamp that has a tubular quartz envelope/bulb/jacket/OJ with a single lead wire exiting a quartz pinch seal at each end. It can be seen, however, that the scope of the innovations presented therein are applicable to a broad variety of LED lamp embodiments comprising LEDs mounted on a PCB that is positioned inside an outer jacket (particularly a glass, not quartz, jacket) that has at least a portion that is cylindrical/tubular in shape. Especially notable is the use of LEDs mounted only on forward/downward facing sides of the LED carrier (folded MCPCB) to achieve a directed beam of light output without using a fixture reflector.

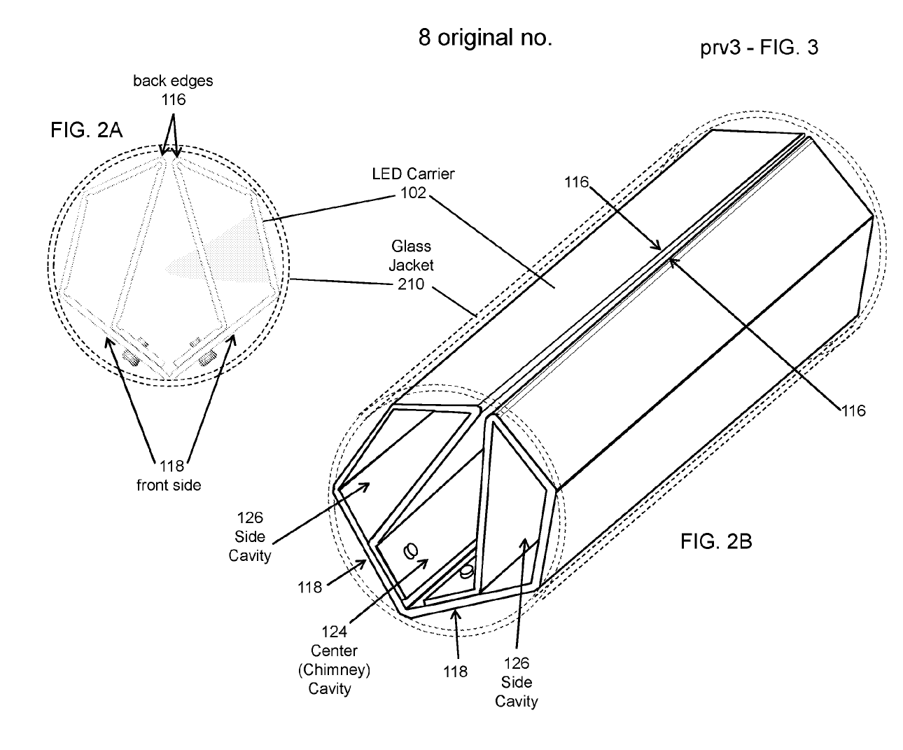

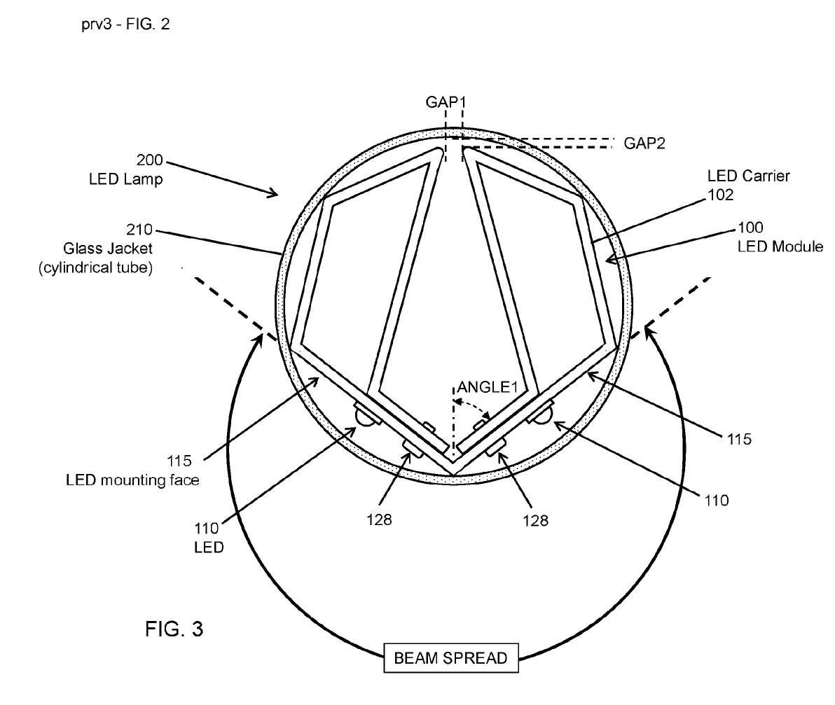

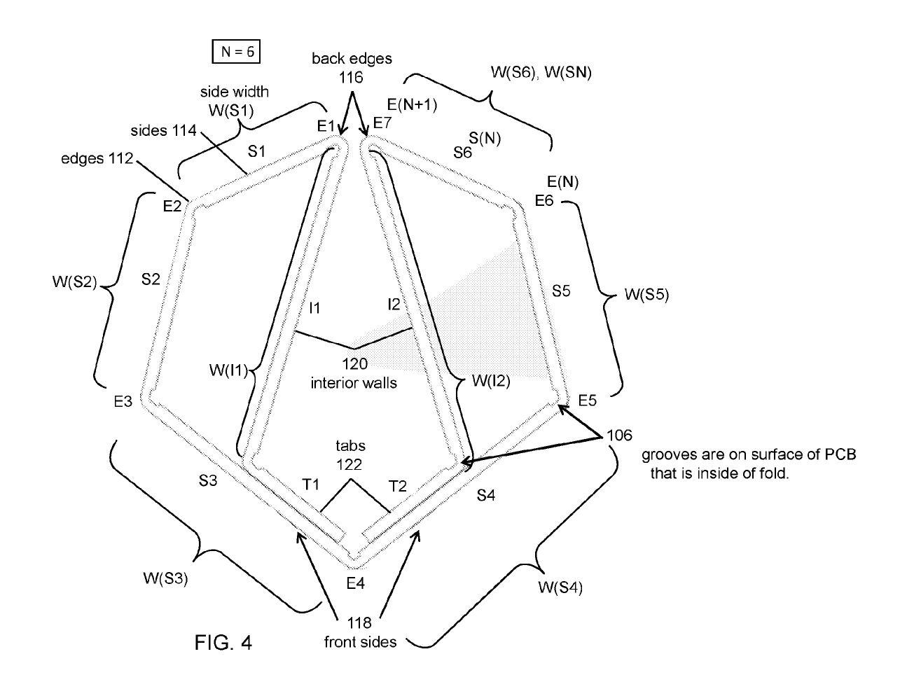

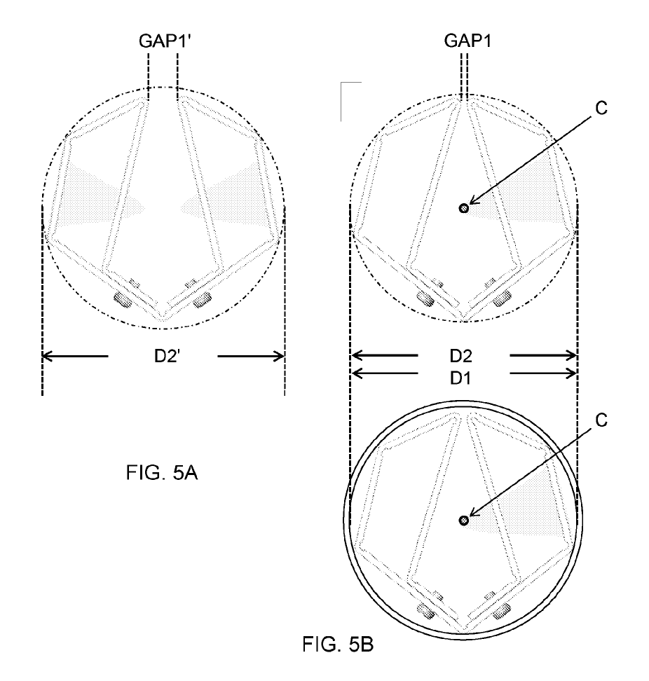

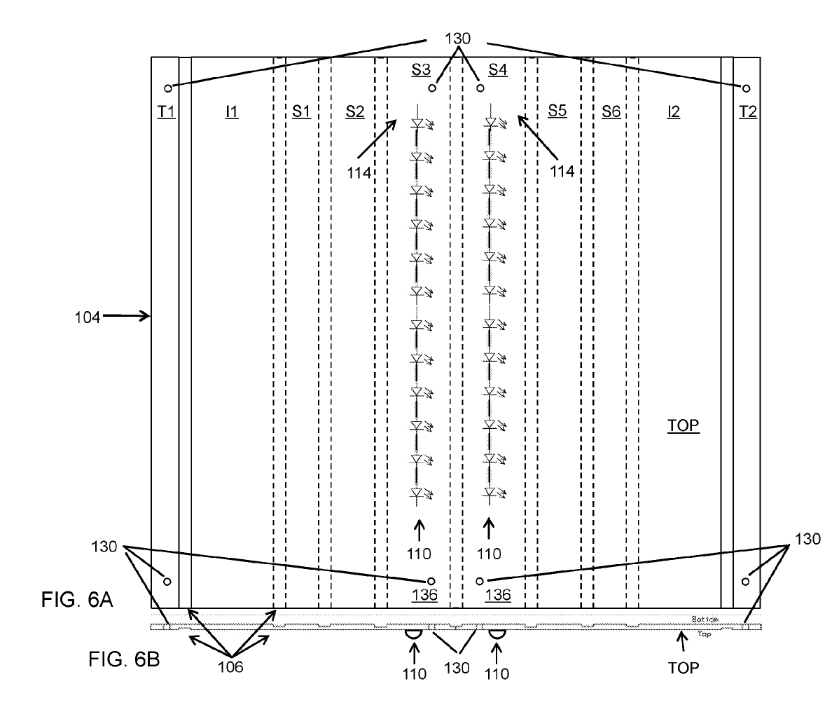

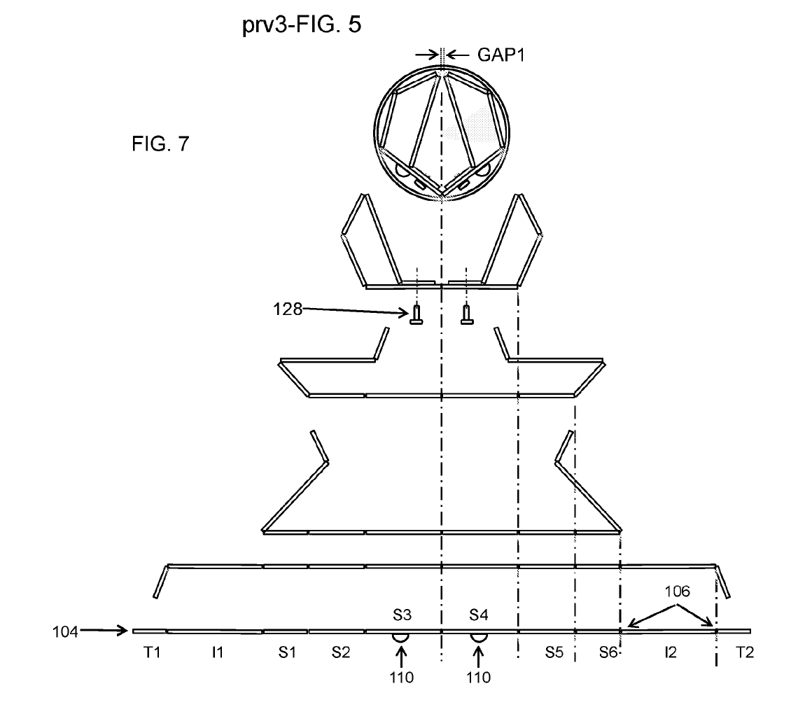

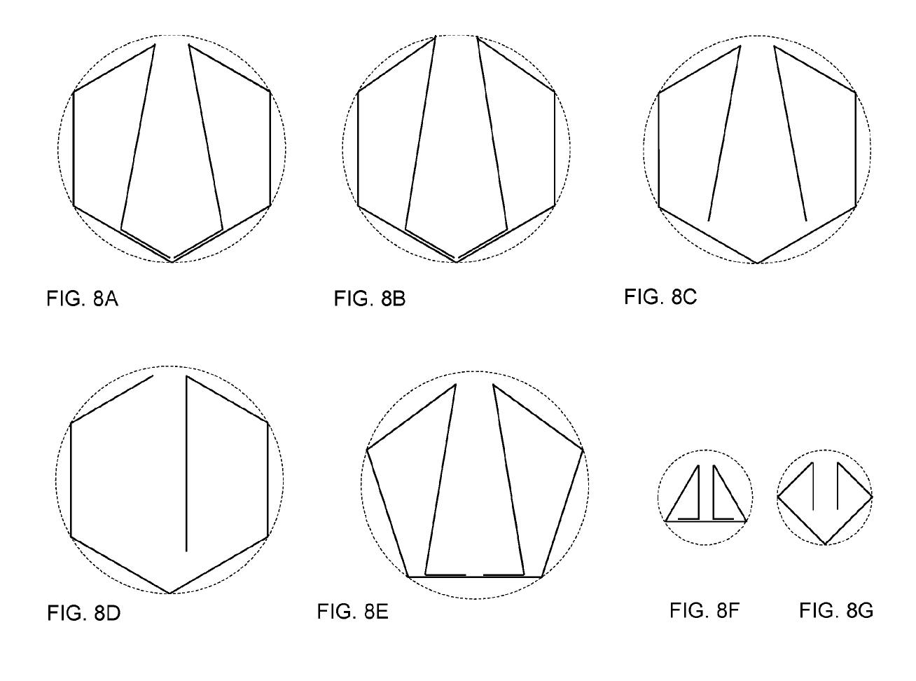

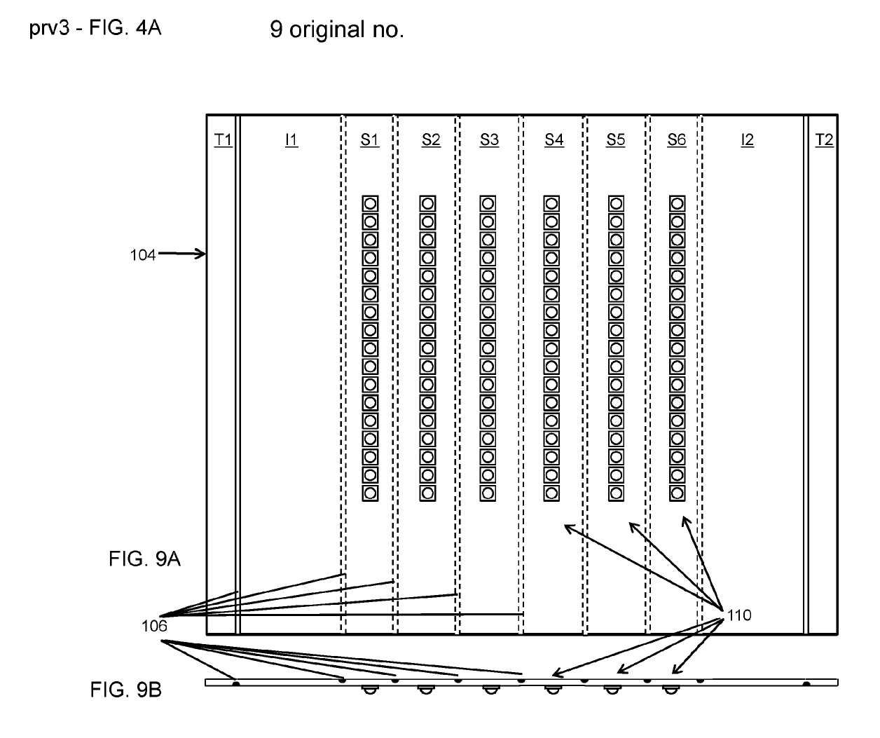

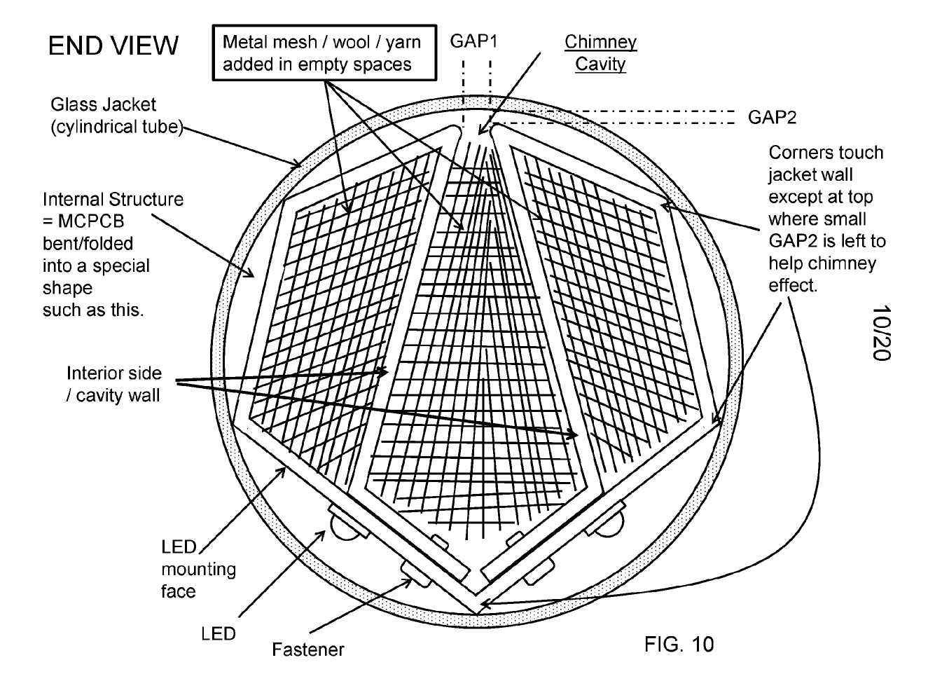

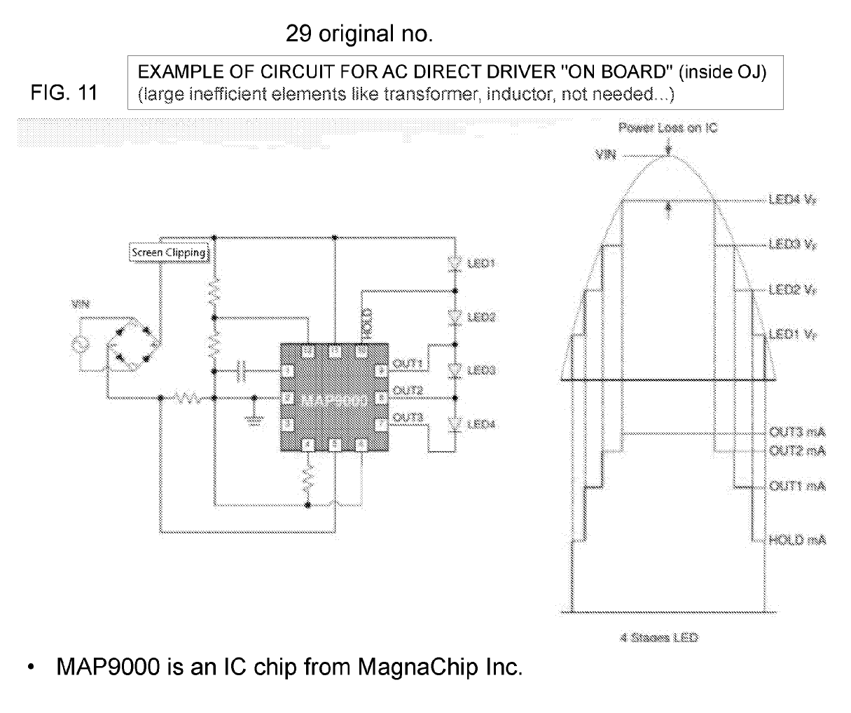

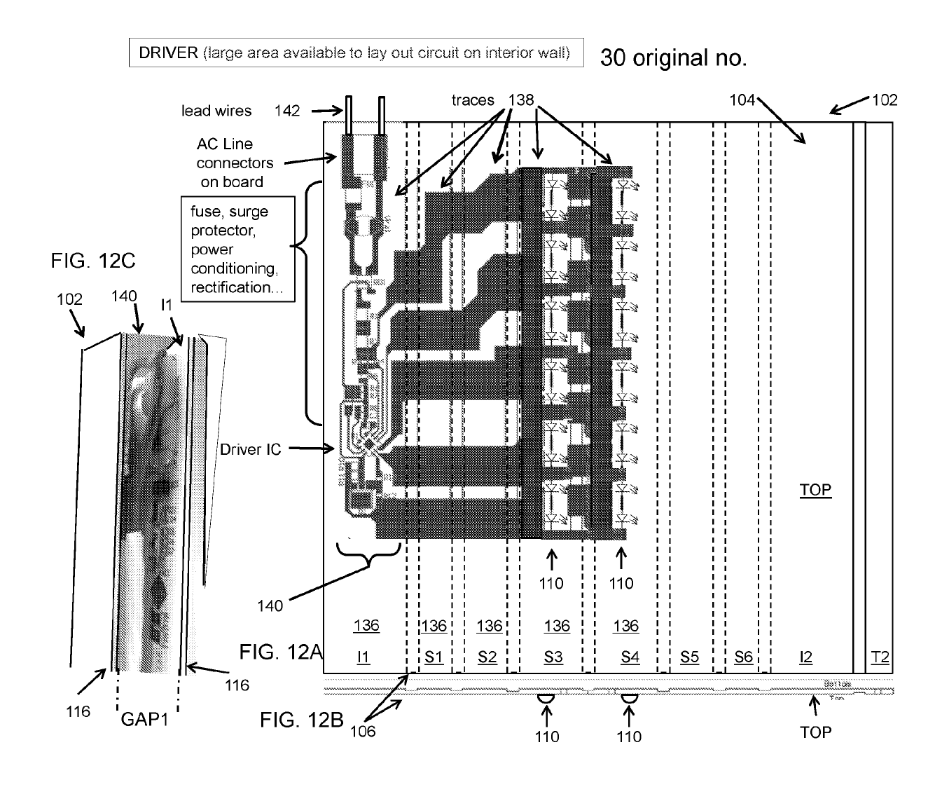

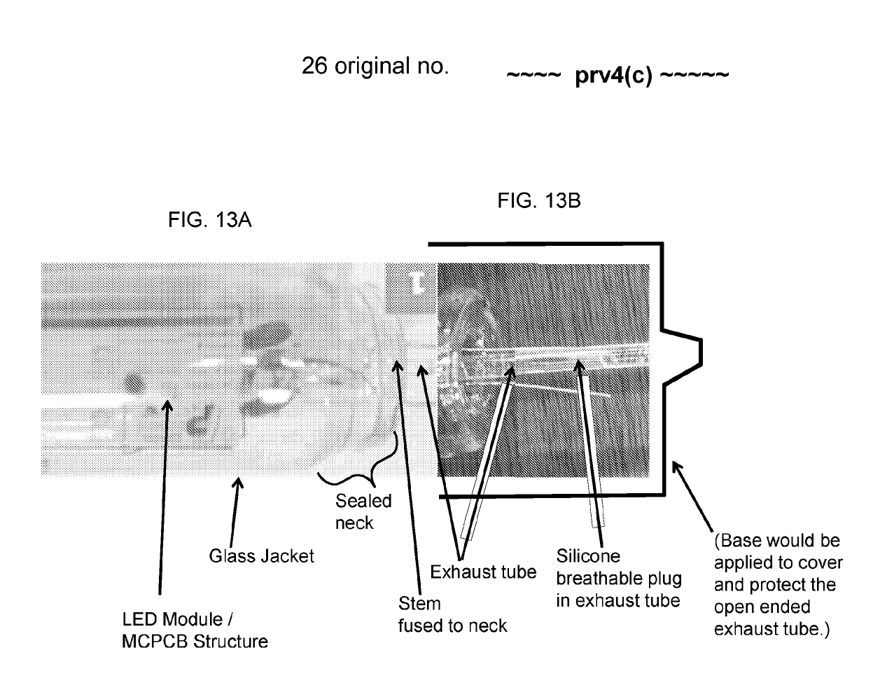

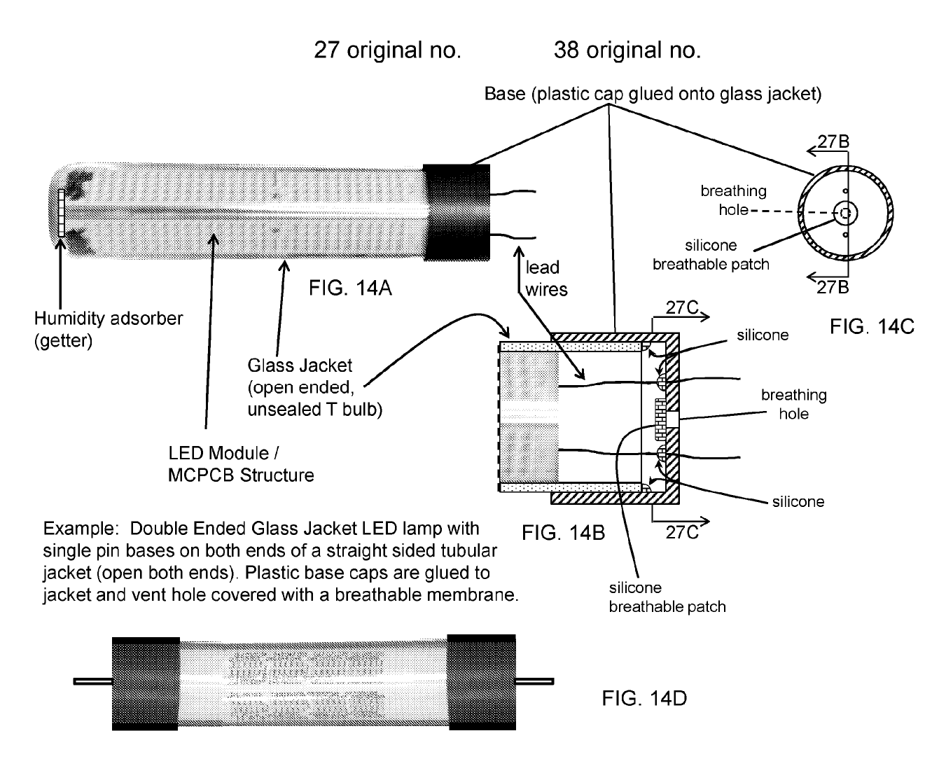

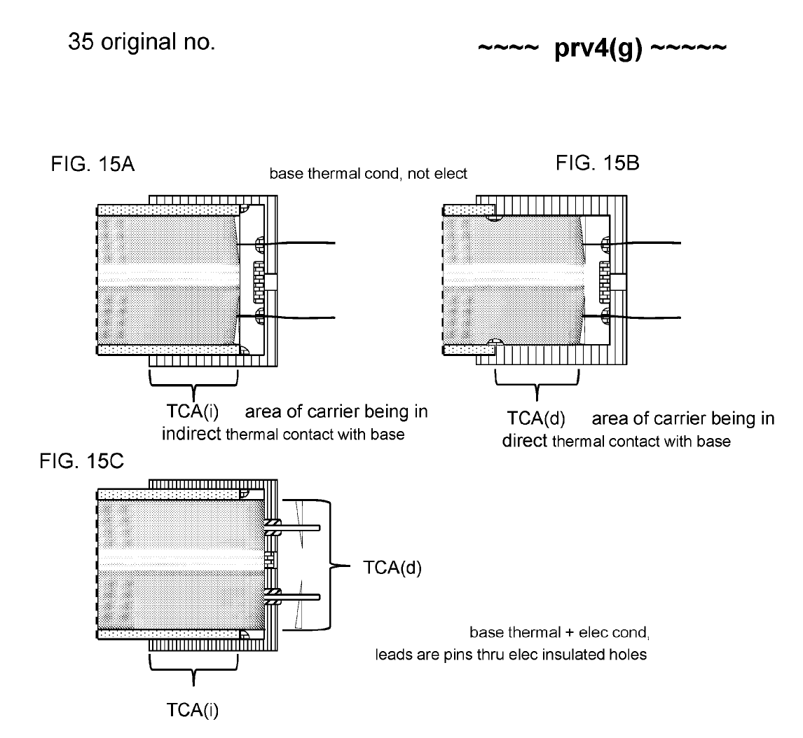

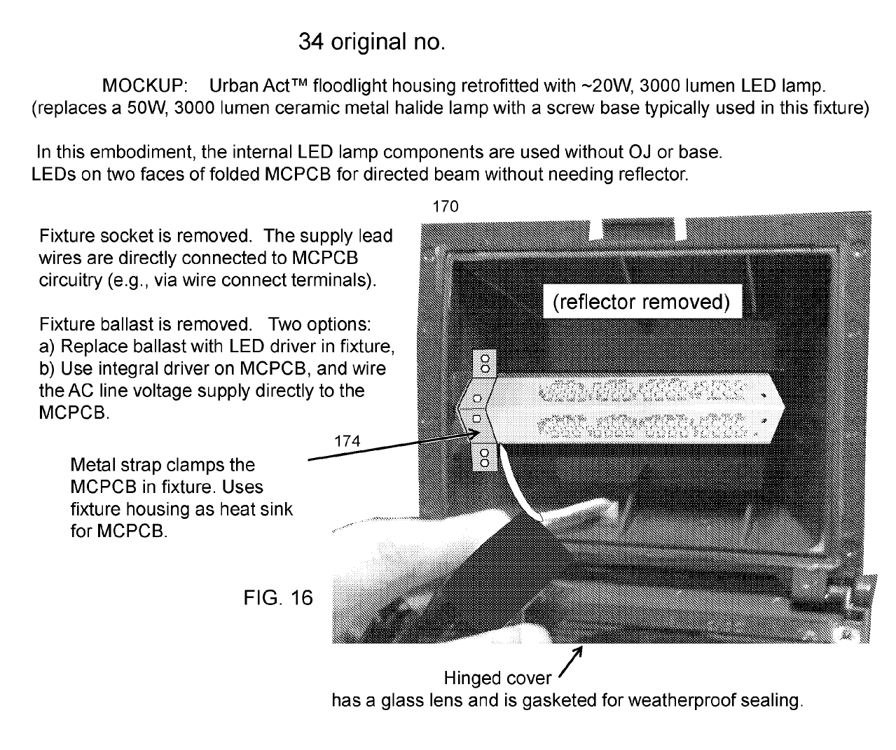

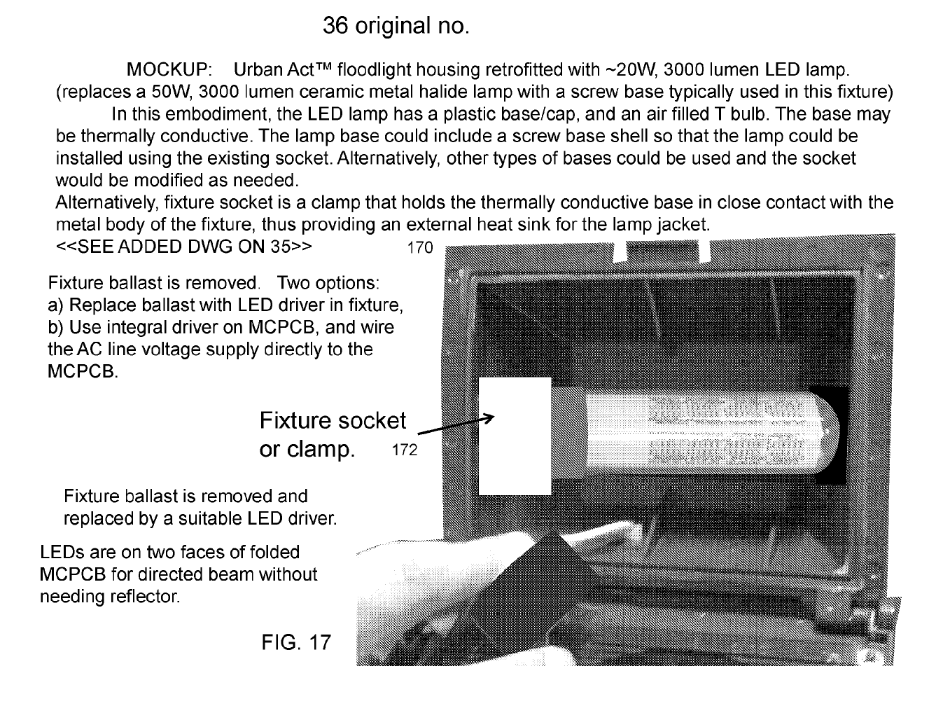

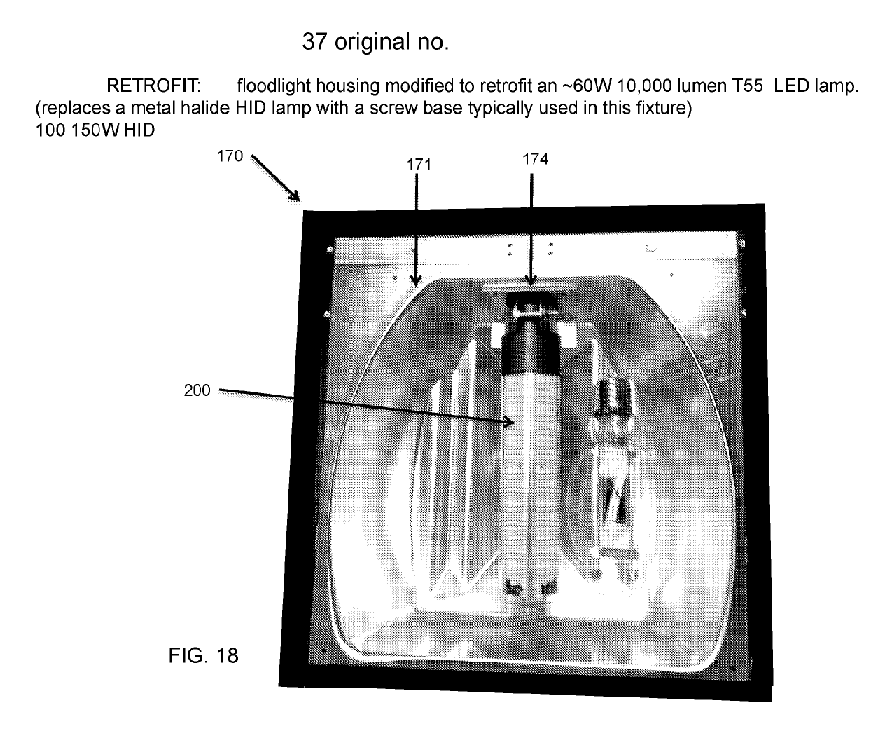

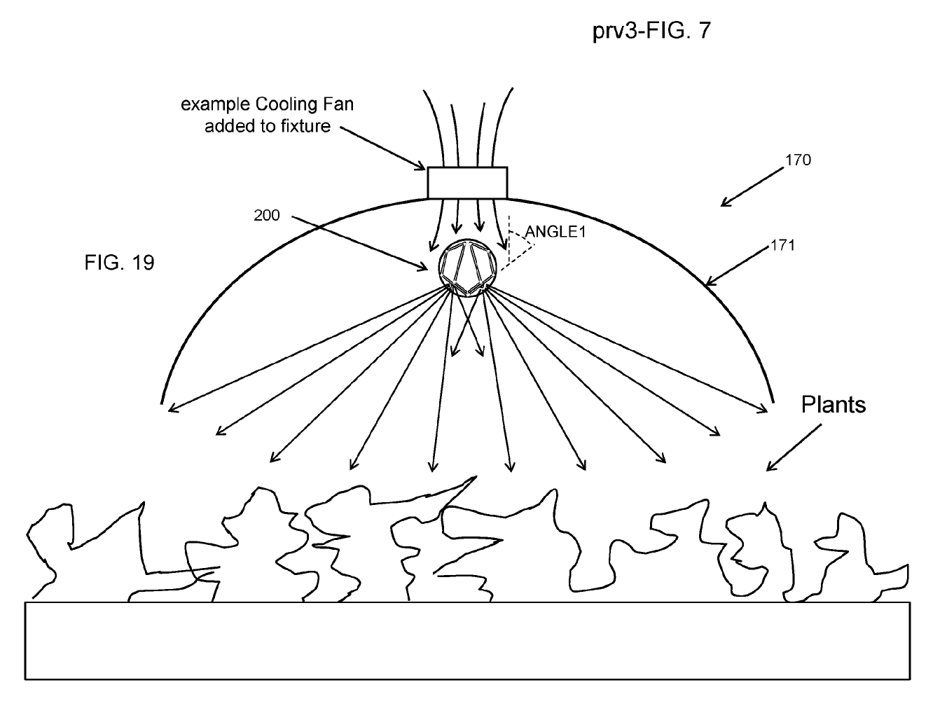

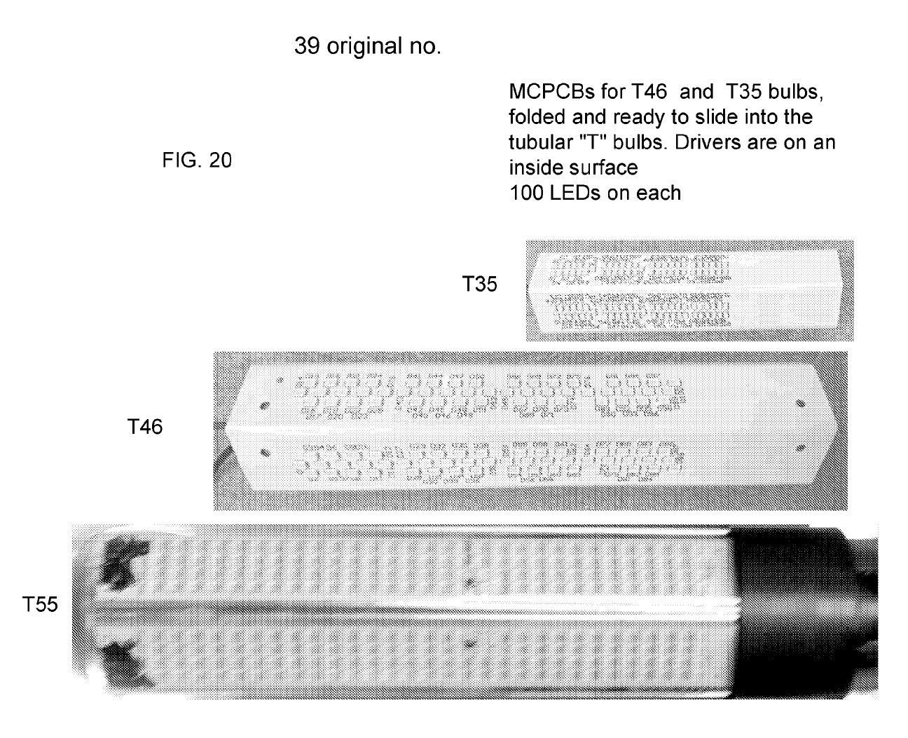

Embodiments of important parts of a glass jacketed LED replacement lamp are now presented with particular reference to an end cross-sectional view and a perspective view shown in FIGS. 2A and 2B, respectively. The illustrated embodiment(s) represent example implementation(s) of the inventive concepts herein disclosed, particularly showing internal lamp structure to effectively decrease thermal resistance to heat transfer from LEDs to glass jacket using thermal conduction and fill gas convection. A pinch seal and electrical connectors etc. would normally be at one or both ends but is omitted to focus on the LED lamp structure relative to the glass jacket.

Referring particularly to FIGS. 5A-5B, the outer jacket is “glass” (e.g., hard glass) instead of quartz, because the LED heating of the jacket is so much less than for the HPS lamp. For lower thermal conductive resistance, we minimize the thickness of glass, constrained by physical requirements such as strength, fragility, durability. Before sealing, the envelope 210 is preferably a cut length of tubing stock with a constant diameter, but at a minimum it has at least one end with an opening at least the same inside diameter D1 as the body of the jacket. The other end may be domed as with a typical “T-bulb”. This is so that the internal structure, the LED carrier 102 of the LED module 100, can be pre-formed to a shape that will have a maximum outside diameter D2 that is approximately equal to the jacket inside diameter D1 when inserted into the jacket 210 (enabling direct contact between structure edges 112 and the glass as shown, for example in FIGS. 5B and 10). The internal structure (i.e., the LED carrier 102) is formed as a convex prismatic polyhedron, and the prism cross section is an irregular and incomplete (optionally irregular) polygon (two sides are separated by “GAP1 ”). As shown in FIGS. 5A-5B the structure 102 is advantageously pre-formed to make its pre-formed diameter D2′ slightly greater than the jacket inside diameter D1 so it can be constricted enough to slide into the jacket 210, then released, thus using its spring-back force as a bias to hold the LED carrier 102 in position by friction. This avoids the need for the base to support the internal structure. Even better, this bias force also establishes firm contact of the edges 112 to the jacket 610 to maximize thermal conductivity, i.e., the edges are in what we term “thermal contact” with the jacket wall. Regarding the internal structure of the lamp 200, our approach is to utilize both conduction and convection to transfer heat from the LED backplane (MCPCB) to the envelope 210 so that it can disperse that heat from its outside surface. As described hereinabove, helium gas filling may be used to increase convective heat/thermal flow, although our later development followed a different route wherein the lamp does not have a hermetically sealed fill gas.

Referring to FIGS. 6A and 12A, The LEDs 110 of the light source (LED module 100) are mounted on a metal printed circuit board (metal PCB a.k.a. MCB, or MCPCB for metal core

PCB) 104 using conventional means including a dielectric surface coating 136 between the metal (aluminum or copper) backplane and the electric circuitry traces 138 printed thereupon. The metal board is used to provide a heat sink for the LEDs. In an embodiment, a polyimide dielectric layer, and copper traces without a solder mask are used, thereby enabling MCPCB bending without cracking, and minimizing potential VOC emissions.

FIGS. 6A-B, 9A-B and 12A-B show MCPCBs 104 that have been prepared according to embodiments of the invention. The plan view shows folding lines (e.g., grooves) 106 that divide it into lengthwise sections (e.g., sides 114, S1-S6), for folding. Examples of LED placement are indicated by symbols. Driver and circuitry are not shown except in FIG. 12A. The quantity and arrangement of LEDs is a function of lamp radiant output specs. Optionally, where those specs allow LED and circuitry placement on some, but not all sections, then only the LED mounting faces may be coated with dielectric material for application of circuit traces etc. used for LED mounting. This not only reduces cost and improves bendability of the MCB, but may also reduce potential outgassing or other problems that might be caused by the coating. Furthermore, uncoated aluminum surfaces are expected to have less thermal resistance to heat transfer (by conduction to gas filling and glass or metal surfaces in thermal contact, and/or emissivity for thermal radiation/IR) away from the MCB which is also the heat sink for the LEDs.

As seen in FIGS. 6A-B the LED placement on only two sides 114 (e.g., “front” mounting faces) enables concentration of all lamp radiant output into a generally forward direction without any losses from reflection by an external reflector. Also viewing FIG. 3, the face angle “ANGLE1” is the angle of the LED Mounting Face 115 relative to the forward direction (e.g., downward or vertical), and this controls beam spread independently of the fixture reflector (although a reflector could be used to limit/reduce beam spread for a given lamp design). Thus ANGLE1 depends on the light distribution requirement (beam spread), which is related with LEDs location and their view angles as well. In general face angle ANGLE1 may be anywhere from 0 to 90 degrees, but practically speaking will be around 30 degrees or more because zero degrees would place the LED backplanes against each other and eliminate the central “chimney” for heat sink cooling. In our testing, a prototype example embodiment exhibited a beam spread of roughly 270 degrees (+/−135 degrees about the forward direction).

The placement of folding lines 106 determines the width of each section/side 114 and the magnitude of parameters such as ANGLE1, GAP1, and GAP2. Varying the quantity of grooves changes the number of sides in the overall polygon shape. Several examples are shown in FIGS. 8A-8G These variations should be bounded by design constraints as follows:
The outside corners (edges) 114 of the structure should be as close as possible to touching the ID of the outer jacket, with the exception of the back edges 116 which have certain gap spacings.
The ANGLE1 (determined by beam spread requirement) is fixed by the width of the two LED mounting faces 115, i.e., the two sides of an isosceles triangle that is formed within the jacket ID around a vertex angle of 2× ANGLE1.
The back edges 116 should be spaced apart by GAP1 dimension and should be spaced away from the jacket ID by a GAP2 dimension.
The inside walls 120 (I1, I2) should form a chimney cavity 124 such that heat rising from back of the LED mounting faces, enhanced by a chimney effect, will circulate up to the OJ through GAP1 and also spread around the jacket ID by passing through GAP2 on either side. This convection cooling also removes heat that is conducted away from the LED backplane by the inside walls of the cavity.
The width of the MCB thermal attachment tabs 122 may be adjusted to control the mass of aluminum present as a double wall thickness behind the LEDs, noting that varying this will also vary the vertical angle of the inside walls of the chimney cavity.
The thermal attachment tabs 122 may fastened securely to the back of the front sides 118 (mounting faces 115) in a way that maximizes the thermal conductivity therebetween, thereby optimizing the heat sinking capacity of the metal mass behind the LEDs. (This also helps stabilize and fix the structure shape and dimensions.) Suitable fastening means may include rivets or screws 128 in holes 130, welding, soldering, thermally conductive adhesive, and the like. The illustrations of mechanical fasteners show a single fastener at each end of the LED mounting face but this is merely representative of any suitable number and placement of such fasteners.

The above description focuses on horizontal burning with the gaps GAP1 and GAP2 providing a chimney cavity opening that is vertically “on top”. It should be noted, however, that the disclosed structure of the folded PCB will provide cooling with enhanced convection regardless of the burning orientation. This is because the structure is open on both longitudinal ends such that the lamp fill gas will circulate into and/or out of the ends as well as the longitudinal edge GAP1. For example, if burned horizontal with the gaps axially rotated to a position in the top 180 degrees, then gas will most likely flow into the cavity from one or both ends and out through the gaps at top. If the gaps are located within the bottom 180 degrees, then circulation may reverse direction. Vertical burning provides the most options for gas flow paths from bottom to top through some of the channels and returning downward through others, the channels being bounded by any of the side walls of the PCB and the inside wall of the surrounding glass jacket.

Referring to FIGS. 4 and 6-9, although the LED support structure (folded MCPCB) may be loosely described herein as a polygon or a hexagon or an octagon (cross section profile), the preferred structure should be interpreted in light of the drawings and description that discloses a polyhedron that is open, not closed (e.g., at GAP1), and may be irregular as well (i.e., unequal side widths 114 and corner angles). We have presented a profile having a plurality of substantially straight sides (e.g., six) around the outside perimeter but preferably having extra sides that extend into the interior cavity from a gap (e.g., GAP1) between adjacent sides, thus leaving the outer polygon open, not closed. The outer polygon may have mostly equal width sides (FIGS. 8, 9), or unequal widths (FIGS. 6A, 6B, 7). The unequal widths may be best for support structures having LEDs mounted on some but not all of the sides, in which case the LED mounting sides may have widths designed to achieve a particular corner angle (e.g., ANGLE1, which produces a desired beam spread). For example (see FIG. 4), dimensions for a 6-sided MCB in T46 or T55 bulbs: width W(S1) through W(S6) of exterior sides 114 is bigger than 10 mm, while the interior side walls 120 are at least 30-50 mm wide (W(I1), W(I2)). Side widths may also be determined by other objectives such as those listed above. For example, a lamp designed for vertical burning may not need the open corner or interior walls (although they are preferred), and may have more sides, potentially having equal width (e.g., eight as shown in FIG. IA) such that all of the structure corners can touch the jacket wall 210. In another embodiment, the structure may be shaped such that LEDs mounted on each side can touch the outer jacket wall for additional heat sinking.

A common factor among the disclosed LED support structure embodiments is that the structure is formed by folding a single sheet of MCPCB material, generally after the electrical elements such as LEDs, circuitry traces and the like have been mounted thereupon. As described hereinbelow, the mounted electrical elements may include LED driver circuitry and components. It can be seen that placement of LEDs, drivers and other elements on a plurality of folded PCB sides will preferably utilize electrical conductors (traces) that are “printed” on the PCB surface in paths that extend across the fold between adjacent sides. This means that the folds must be gentle curves that do not stretch, wrinkle, or otherwise potentially damage electrical continuity of the traces. Thus the “grooves” 106 are cut into the side opposite from the mounting surface having the traces and the LEDs in a way that prevents metal from bunching on the inside of the bend because that might stretch the mounting surface. Furthermore, these considerations may be modified to accommodate changes of the MCPCB board in order to reduce VM (volatile material) emission inside the lamp.

Getters in GJ LED Lamps

The heat of sealing can damage the MCPCB directly (e.g., blackening the surface). Furthermore heat from sealing and heat from burning the LEDs may result in outgassing, i.e., emission of volatile materials (VMs) such as VOCs (volatile organic compounds) and water (vapor) from lamp components such as the MCPCB, LEDs, and/or glass jacket (particularly from materials used in some adhesives, coatings, gaskets, plastics, solder flux, solder mask, conformal coating, and the like). There may also be humidity (water vapor) in the gas filling (especially if lamp is vented to ambient air). If not prevented or eliminated then the VOCs and water attack and degrade the MCPCB and LEDs. For example, VOCs and/or water vapor may penetrate into the LEDs (e.g., permeating through a silicone lens) causing aging, shortened life, color change, and/or rapidly decreasing light output due to corrosion and/or chemical reactions. Furthermore, liquid water (e.g., condensed water vapor) can cause shorting of circuitry, especially if LED driver circuitry is inside the lamp. Byproducts of chemical reactions with VOCs also may be deposited on the bulb inner wall, causing blackening which decreases light output.

VOCs may outgas, for example, from elements typically associated with a PCB (MCPCB), e.g., a dielectric coating, solder, flux, and/or solder mask materials. Therefor one way to reduce outgassing is to minimize if not eliminate the outgassing source materials. For example, the MCPCB may be bare metal (without coatings etc.) on all sides except where needed to mount and electrically connect the LEDs on the LED mounting face(s), e.g., just the two middle sections of the board.

Outgassing is a function of time and temperature, therefor another way to reduce outgassing is to minimize the operating temperature of the outgassing source materials. Our folded MCPCB design provides a very efficient heat sink which minimizes operating temperature of the LEDs. Heat sink efficiency is optimized by several of our design factors, including for example:
very large MCPCB surface area that is exposed to gas convection cooling, including extra area along the interior cavity walls,
unusually effective heat transfer to the outer jacket by conduction from long edges/corners of the MCPCB that are spring biased to be held firmly in contact with the OJ.
extra paths for conducting heat away from the LEDs (interior walls attached to back of LED mounting side)
metal wool benefits two ways: extra paths for conducting heat away from the LEDs, plus a very large effective surface area for gas convection cooling
chimney effect along multiple paths in and around portions of the MCPCB (cavity, GAP1, GAP2, space between MCPCB outside walls and the nearby OJ wall.)
long edges of folded MCPCB firmly held in contact with jacket wall
optional driver on board is mounted on cavity interior wall, not close to LEDs

Additionally, it may help to pre-treat any potential VM emitting materials to remove as much as possible of VMs before sealing the light source into the outer jacket. For example, the LED module can be baked at elevated temperature before enclosing it in outer jacket and base or glass seal.

In addition to the above described methods for preventing and/or minimizing VM contamination, sealed LED lamps may need methods for removing and/or preventing the accumulation of harmful contaminants (e.g., VMs) inside the jacket over the life of the lamp. Contaminant removing components are typically referenced as “getters” in lighting products, wherein a getter functions by trapping and holding the contaminants, thus removing them from the lamp filling.

It may be noted that, in prior art LED lamps, use of getters for contaminant removal are typically not mentioned, likely because, for example, the prior art modules may not get as hot (e.g., with external heat sinking or low wattage), and/or VM emission is at a low rate that can dissipate and/or be diluted to harmless concentrations by a relatively large volume enclosure (which may be vented and/or not completely enclosed). For example, U.S. Pat. No. 8,757,839 by Hussell (Cree) discusses potential VOC contamination in column 11 of the detailed description, however they solve the problem by other methods, such as adding oxygen, or a blocking substance added to the LED. We note that they are only looking at relatively low wattages, i.e., the LED equivalents for 60W and 40W incandescent lamps. (A typical 60W equivalent outputs 800 lumens and consumes about 9.5W total). We are dealing with much more heat in the envelope, e.g., up to 50-60W of operating power. Therefor we believe getters are needed, especially in sealed enclosures.

The VMs typically include both high polarity types (e.g., acetone, methyl/ethyl alcohol and water); and low polarity types, (e.g., hexane, toluene, etc.). To getter the VOCs, our research concludes that a combination of active carbon, natural zeolites, de-aluminized zeolites, and/or surface treated zeolite like organic hydrophobic silane should be effective for minimizing lamp damage due to outgassing. Active carbon is a universal adsorbent of VMs due to its non-polar surface affinity and random mixture of pore sizes. Furthermore, a desiccant (e.g., silica) is highly hydrophilic and therefor particularly effective in adsorbing water preferentially over the VOCs likely to be in the lamp. Therefore the desiccant can handle large amounts of water, preventing the other getters from being overwhelmed by water, so they can focus on VOC adsorption. Zeolites are three-dimensional, microporous, crystalline solids with well-defined structures that contain aluminum, silicon, and oxygen in their regular framework. The silicon and aluminum atoms are tetrahedrally coordinated with each other through shared oxygen atoms. Zeolites are natural minerals that are mined in many parts of the world; but most zeolites used commercially are produced synthetically. Zeolites have void space (cavities or channels) that can adsorb cations, water, or other molecules. Because of their regular and reproducible structure, they behave in a predictable fashion. Zeolites can separate molecules based on: size, shape, polarity, and degree of unsaturation, among others, thus may be called “molecular sieves”.

In addition to selectivity based on size and configuration, zeolites will preferentially adsorb molecules based on polarity and degree of unsaturation in organic molecules,. In a mixture of molecules small enough to enter the pores, the molecules with lower volatility, increased polarity, and a greater degree of unsaturation will be more tightly held within the crystal. Therefor we conclude that pore size should be bigger than VM molecule size in order to trap them.

All naturally occurring zeolite contains aluminum and is hydrophilic (having an affinity for polar molecules, such as water and some of the VOCs.) De-aluminizing natural zeolite makes it hydrophobic (having affinity for non-polar substances, such as many of the VOCs). Zeolite is de-aluminized by chemical replacement of aluminum with silicon without changing the crystal structure.

Activated/active carbon has been treated to create a very large surface area available for adsorption and/or chemical reactions. The surface area comes from a randomly complex structure that has a large quantity of pores that may be various sizes (micro-pores, macro-, etc.). Adsorption by trapping in pores occurs similarly to zeolites, except that it has a neutral (non-polar) surface affinity making it potentially a universal adsorbent of all VMs including water.

Desiccants are solid materials that adsorb water (are hydrophilic). Thus, certain zeolites and forms of active carbon can be used as desiccants, but other materials are also available for this specific purpose. Silica is a well known, excellent desiccant. It is porous and polar and has a strong affinity for water. Advantages include:
it is not used up by adsorbing anything other than water molecules
chemically inert
high capacity for retaining adsorbed water
captures both liquid and vapor forms of water
inexpensive and readily available in a variety of forms, e.g., crystalline, gel, in capsules, in flexible skins, etc.

Therefor we conclude the following:
Zeolite pore size should be bigger than 4 A to trap expected VMs.
Hydrophilic & hydrophobic zeolite should both be used because expected VMs include both high and low polarity molecules.
Active carbon can be used to supplement zeolites for maximum adsorption of all VMs.
Desiccants can be used to prevent other getters from being overwhelmed by water.

Referring to FIG. 14A, the getter(s) are preferably positioned at the lowest possible temperature location in the operating lamp, e.g., at an end of a horizontally burning lamp in order to avoid releasing the gases that have been adsorbed.

The description so far assumes that the outer jacket (bulb) is hermetically sealed and filled with an inert gas, preferably one that has a high thermal conductivity and/or which enhances convective heat transfer from the LEDs and MCPCB to the bulb. Helium and hydrogen are particularly suitable.

Metal Wool Heat Conductive Filling

In the previous description the interior sides (cavity walls) of the LED carrier structure (bendable/folded MCPCB) are presented as heat sink surfaces that are attached to the back of an LED mounting surface. They can conduct LED waste heat away and spread it out along the wide wall where gas convection may transfer the heat out to the glass jacket. This heat sinking is most effective for the MCPCB outer sides to which the interior walls are fastened, for example the two

LED mounting faces shown in the drawings. However, at least two of the outer sides are not directly attached to an interior side wall, but they may also have LEDs mounted on them. Therefor an added way to enhance heat sinking of all the MCPCB walls/sides is presented: As schematically illustrated in FIG. 10, a thermally conductive light weight material is used to fill cavities inside the folded MCPCB carrier structure. In a preferred embodiment the filler is a high thermal conductivity metal (e.g., aluminum or copper) in a porous but highly interconnected form such as “wool” (or mesh or yarn and the like). The metal wool should fill the space, firmly contacting the MCPCB walls that surround it, thereby increasing the effective thermal conductivity of the gas/air filling without increasing lamp weight much. Also, because it is porous it becomes a extremely good means for convective heat extraction by any circulation of the fill gas through the wool-filled cavity. Suitable metals or alloys preferably have a thermal conductivity greater than 10 W/mK.

This approach can significantly decrease the localized LED temperature even when using air instead of a more conductive/convective gas filling like He or Hydrogen that have higher thermal transfer rates. For example a 27 W T46 LED lamp was tested. It had two LED mounting faces and an integrated AC direct LED driver mounted on one of the interior cavity walls*. It was an air filled* glass jacket with aluminum wool filling the two side cavities. When operated in a horizontal orientation, the temperature difference between front glass (LED emission area) and back glass was only 1 degree C. The highest temperature on the glass surface was only 71 C at ambient 24 C.

*Note: the integrated “on board” driver, and features enabling air as fill gas, are described hereinbelow.
unsealed (air filled) OJ with breathable plug to vent outgassed VM, and humidity adsorber

As disclosed above and in previous provisional applications, the LED lamp embodiments of this disclosure generally comprise an LED module contained in a bulb/envelope/jacket 210. The module is an LED carrier structure upon which is mounted one or more arrays of LEDs along with interconnecting electrical circuitry. The carrier is a metal printed circuit board (MCPCB) designed to conduct heat away from the LED junctions, thereby functioning as the first part of a heat sink. The OJ (jacket) is used to protect the LED module components from performance-decreasing damage/deterioration caused by, for example: ambient conditions (e.g., moisture, dirt, chemicals, salt water air), physical contact (e.g., handling, bumping fixture components, collision with moving objects), and the like. The OJ may enable the use of LED's that cannot be used in air, in which case the OJ must be sealed and filled with an inert gas. The OJ may be utilized as a means for dissipating heat generated by the LEDs, for example: using a T bulb tightly fitted around a coaxial LED carrier structure wherein folded MCPCB corners/edges and/or LEDs may touch the jacket's inner wall; using a structure that enhances convective heat transfer from the

LEDs to the jacket; and sealing the bulb with a gas filling at elevated pressure and/or using gases such as helium or hydrogen, all to achieve greater effective thermal conductivity than air or nitrogen.

There are some problems caused by hermetically sealing the LED light source in the outer jacket. Lamp sealing typically involves heating the bulb (OJ) neck enough to neck down and fuse with the flange of a sealing stem that contains electrical lead wires and an exhaust tube, then flush-filling through the exhaust tube before melting it closed (“tipping”). As disclosed, the following problems typically need to be addressed when sealing the LED module inside a glass jacket:
a. sealing heat damaging the module
b. inrush of gas filling via exhaust tube damaging coatings such as phosphors (if present)
c. VOCs outgassing from MCPCB heated by the LEDs accumulate over time to concentrations that damage components and deteriorate LED performance in unacceptably short time frame
d. humidity may be trapped inside (especially with air filling), causing damage such as corrosion
e. gas movement is restricted, limiting convection cooling effectiveness (which can cause LED damage if cooling is inadequate)

These problems have been addressed in the above disclosure(s), e.g., by using getters, but results may not be optimum, therefor we extended our efforts to lamps without a hermetic seal, i.e., using ambient air as the “gas filling”. An advantage of this is reduced cost (no He or H2 and no filling operation). Further cost benefits could accrue by eliminating glass-melting to seal the OJ. An important benefit of an unsealed lamp like this is that it “breathes” so that the outgassing VMs may escape rather than accumulate to unacceptable levels, and/or depleting the getter effectiveness.

Although we want to vent outgassed contaminants, we need to prevent ingress of water. Our solution is to provide a WATER BLOCKING filter. The illustration on sheet 26 shows an example where the un-tipped exhaust tube is plugged by a polymer based breathable membrane, like silicone, esp. methyl type silicone which has excellent gas permeability (e.g., VOCs and water vapor) but blocks passage of water, effectively filtering it out. We use a two-part silicone that doesn't emit VOCs while curing. This membrane allows outgas vapors to exit the lamp to avoid their influences on lamp lumen maintenance.

It may be noted that the silicone membrane has excellent permeability for water vapor, which is a two edged sword. Permeation is driven in part by partial pressure gradient, so VOCs and water vapor will transfer from high to low pressure sides of the membrane. This is good for VOCs which are generally non-existing or at a very low concentration outside a lamp, but this could be a problem if the lamp is operated in a high humidity, high temperature environment. As compensating factors, the relatively small size of the membrane covered vent hole and the thickness of the membrane will keep permeation at a slow rate to average the effect over time, plus whenever the lamp is operating, any internal water vapor will be at an elevated partial pressure compared to the relatively cooler humid air outside. As a safe guard, a desiccant/humidity adsorber is included in the lamp, such as, for example, active carbon, hygroscopic zeolites, silica (e.g., silica gel), and the like. The silica may be optimum because it is so effective in focusing on water adsorption. It is also very inexpensive. Preferably getter for the VOCs is also included, but not as much is needed for this lamp compared to what is needed in a hermetically sealed lamp.

The exhaust tube with breathable plug (but left open ended, not tipped) may be cut short and protectively covered by a lamp base applied to the glass seal area. The base would have to be vented (FIGS. 13A-B).
plastic cap glued on instead of heat sealed glass (preferably clamped in fixture, not screw base) and vent hole is covered by a sticker/patch version of the silicone membrane

FIGS. 14A-C illustrate a further improvement of the unsealed OJ concept which eliminates the melted glass neck seal area fused to a stem flange, and the “base” may be simply glued (e.g., silicone adhesive) or otherwise adhered onto the open end of a simple tubular OJ (e.g., glass). This avoids all manufacturing process heating and the potential damaging effects of that, plus it significantly reduces costs. The base could be any shape that allows breathable membrane venting at the open end (straight neck) of the T-bulb. For example, a standard metal screw base or DC cylindrical base (neither illustrated), with a suitably dimensioned collar on its open end could be used. Or, for example, a simple cylindrical cap, preferably plastic, may be used as shown (also see note below). When used in the present context of an adhesive-like material (e.g., silicone sealant and/or adhesive) that is applied to components of the base and outer jacket, the term “seal” (and its variants) means at least preventing passage of water (i.e., a breathable patch/plug/material). Otherwise, unless specified as breathable, a “sealing material” may block passage of any or all liquids and gases reasonably expected to be present in the lamp operating environment.

The base may be sealed by adhesive inside the base around the GJ end and by sealant applied where the lead wires exit, leaving a breathing hole covered by a patch of breathable membrane. Optionally all of the sealant and/or adhesive materials may be breathable. As in the previous example, the breathable material will allow VMs to escape the lamp interior (e.g., through the breathing hole) while preventing ingress of water.

Advantageously, the plastic cap is made from thermally conductive plastics, like graphene blended thermal plastic. For thermally conductive plastic, it has two kinds, one is graphene blended, which is thermally conductive up to 20 W/mK but also electrically conductive. The other kind is BN blended thermal plastic, which has thermal conductivity up to 2 W/mK but electrically insulating. Due to glass is super electrically insulative material and lead wire can be sheathed by electrical insulation material like PVC, it is preferable to use graphene type thermally conductive plastic for the cap.

The benefit of using a thermally conductive plastic cap/base, is to build a thermally conductive heat dissipation path from the glass jacket to a base holder (e.g., socket, clamp, and the like) and then to the external fixture housing, which then exchanges thermal energy to ambient air as a fixture heat sink. Figures on drawing sheets 34 and 36 show how a bracket/clamp can hold the thermally conductive base in close contact with the metal body of a fixture.

Because air at ambient pressure does not have the thermal conductivity/convection advantages of high pressure fillings, particularly He or H2, we optimize the LED module-to-glass jacket heat transfer ability in other ways. We find that adding the metal wool cavity filling to the folded MCPCB with the shape and relative dimensions described above appears to be adequate to prevent LED self-heating thermal damage. Furthermore, damage from heat-sealing is prevented by use of a tubular (T) bulb (preferably straight sided, i.e., no neck) with an end-cap/base adhered over the open tube end. Finally, damage due to lamp contaminants (particularly VMs, both VOC and water) is avoided by a combination of venting the lamp through a breathing hole covered by a breathable plug/patch that passes water vapor and VOCs but not water, plus some measures to minimize initial VM content and to getter any ongoing outgas sing of whatever VMs may remain. A preferred suitable material for the breathable plug/membrane/waterproofing sealant is methyl type silicone, which has high permeability for gases such as VOCs and water vapor, but blocks water (liquid). As described in the getter section of the present disclosure, measures to minimize initial VM content may include elimination or minimum use of VOC emitting materials on the MCPCB. When these measures are combined with the filtered (waterproofed) breathable base the need for getters is greatly reduced versus the fused-glass hermetically sealed lamp. Since condensed water cannot escape through the filter plug a desiccant is still recommended. A small amount of active carbon or zeolite may also be used as a safety margin to control VOC emissions that may build up faster than they can be vented.

Extra getter may be needed if LED driver(s) are added as described below, because they add to the heat load inside the finished lamp. For example, our present on-board driver adds about 10% to the lamp wattage, i.e., approximately 3 W of heat added to an LED module that operates LEDs totaling 27 W of energy consumption (much of which passes out through the bulb as radiant energy/light).

As illustrated in FIG. 16, heat may be directly conducted away from the MCPCB through thermal contact with the fixture instead of indirect transfer through the glass jacket to ambient air. The thermally conductive base can be used on our air filled lamp to implement this principle even when a glass jacket is present, simply by extending the MCPCB to establish close thermal contact with the base, which may then be clamped in a fixture as shown in FIGS. 17-18.

Referring to FIGS. 15A-C, the MCPCB may extend to the end of the OJ where the base overlaps, or even better the MCPCB extends beyond the end of the OJ to directly contact the base. The base would still be made watertight by sealant/adhesive and breathable membrane as described above.
LED driver(s) “on board” (on LED carrier/MCPCB)

The folded MCPCB design has provided extra circuit board space that does not interfere with LED mounting space. By mounting the LED driver circuit on the “top” surface of the MCPCB it can be connected to the LEDs using printed circuit traces. As shown in sheet 30, the folding grooves on the bottom side make the MCPCB thin enough to bend/fold with a radius of curvature that doesn't damage the traces that cross the fold.

The driver is preferably positioned on one of the interior cavity walls (see sheets 30-31), where heat from it can be sinked without affecting temperature of LEDs that would otherwise be adjacent.

Sheet 29 shows an example driver circuit. Without using inductance or transformer, it only utilizes a bridge circuit, surface mounted IC chip, MOSFET resistor and capacitor to combine the AC voltage waveform with forward voltage of LEDs to realize DC driving of the LEDs. The circuit uses a MagnaChip LED driver that is a compact PCB mountable chip (e.g., MAP9000 in diagram). An LED driver and multi HV MOSFETs are integrated into one package. It can drive several LEDs in series from rectified AC line voltage. This provides AC directly converted to DC through an IC chip instead of needing a bulky transformer and inductor.

We implement the driver on board (DoB) for both 120V AC and 277V AC line voltages, and combined with different amounts LEDs. We are first implementing this on MCPCBs sized for T35, T46, and T55 bulb/OJ. The T35 layout is very challenging because of the small area available for the driver circuitry.

In most of the prior art driver on board (DoB) applications, the DoB components are mounted with LEDs in the same planar area of the flat MCPCB of the LED module. Limited space means must use inductor or transformer. But, in our application, by utilizing the benefits of our bendable MCPCB, it allows complicated wiring on a big area of MCPCB and allows locating the DoB components (IC, MOSFET, resistors, capacitor, etc.) in a non-LEDs side (section) of the MCPCB, thus locating the heating effect of the driver far from the LEDs. Driver cooling is enhanced by its placement in the cavity with chimney effect cooling.

In a preferred embodiment of the MCPCB with on-board driver we use PI (polyimide) as the dielectric layer to get best MCPCB bending without cracking, and without using a solder mask layer for copper trace to minimize the potential VOCs. In an embodiment, the board thickness is 1.6mm, with groove is 0.5 mm, and the LED is Everlight KK6C, T1 bin.
No-Jacket Variant

FIG. 18 illustrates use of a simplified VOC dispersing and heat sinked version wherein a non-jacketed LED lamp may be put in a weathertight fixture that has its own protective lens/cover glass. Heat sinking may be enhanced by attaching a thermally conductive mounting bracket/clamp to the MCPCB that conducts heat away to the fixture frame/structure (e.g., Urban Act floodlight fixture that normally uses 50W or 75W CMH lamps, 4-6″ long, horizontal burning in a reflector.) The reflector is removed because it is not needed when the LED lamp has LEDs on two sides, yielding approximately 270 degree beam spread without using reflector as shown in sheet 33.
Refinements, More Details And/Or Improvements

As shown in drawings on sheets 34, 36 and 37, embodiments of our new GJ LED lamp design may be used to replace HID lamps & ballasts by retrofitting in old fixtures (e.g., “shoebox”). (HID includes MH, CMH).

Sheet 37 shows a floodlight housing modified to retrofit an approximately 60W 10,000 lumen T55 LED test lamp. This replaces a metal halide HID lamp with a screw base typically used in this fixture (shown lying in the reflector for illustrative comparison). In this embodiment, the LED lamp has a thermally conductive plastic base/cap, and an air filled T55 (55 mm diameter) bulb. The fixture (hinged lid with cover glass not shown) is modified to remove the mogul socket and replace it with a heat sinking screw clamp (that also enables aiming the two faced LED module). The reflector is somewhat redundant because the two LED mounting faces are angled to direct most of the light outward. The reflector does some beam shaping and establishes cutoff limits (on uplight for example).

FIG. 14D illustrates an embodiment having a plastic base/cap on both ends, so that a plain cylindrical tube can be used without needing a domed end, thus providing a cost savings. Suitable for retrofitting in a fixture for a double ended T bulb. Plastic base caps (optionally thermally conductive) are glued to jacket and a vent hole is covered with a breathable membrane.

LEDs can be applied to any or all outside surfaces of the folded MCPCB to achieve directional or non-directional lighting, as described above.

At present, the following are approximate specs, partly based on testing to date, for 3 versions (power includes on-board LED driver, which adds roughly 10% to the LED power):
T35 bulb: 20 W, 3,000 lm
T46 bulb: 30-38 W, 5,000 lm
T55 bulb: 50W, 6,000 lm; 52W, 6500 lm; and 60 W, 10,000 lm

FIG. 20 shows a prototype T55 lamp compared to prototype T35 and T46 LED carriers.

Example test results:

A 27 W T46 DoB integrated (which adds 3 W), air filled glass jacket lamp with Al wool tested under direct AC line with mogul e base on horizontal direction.

The temperature difference between front glass (LED emission area) and back glass is only 1 C. The basic reason for so small temperature difference is really from the filled Al wool in the cavity of bended MCPCB to successfully minimize the thermal resistance between front and back side glass jacket.

The highest temperature on glass surface is only 71 C at ambient 24 C.

Although the invention has been illustrated and described in detail in the drawings and foregoing description, the same is to be considered as illustrative and not restrictive in character—it being understood that the embodiments shown and described have been selected as representative examples including presently preferred embodiments plus others indicative of the nature of changes and modifications that come within the spirit of the invention(s) being disclosed and within the scope of invention(s) as claimed in this and any other applications that incorporate relevant portions of the present disclosure for support of those claims. Undoubtedly, other “variations” based on the teachings set forth herein will occur to one having ordinary skill in the art to which the present invention most nearly pertains, and such variations are intended to be within the scope of the present disclosure and of any claims to invention supported by said disclosure.

What is claimed is:

1. A glass jacketed led lamp comprising:
a prismatic LED module positioned coaxial to the axis of a cylindrical glass jacket having an inside diameter D1, wherein the LED module comprises:
a prismatic LED carrier structure having N longitudinal sides, and LEDs that are operationally mounted on at least one of the N sides; wherein:
the carrier structure was formed by folding a single metal core printed circuit board (MCPCB) into a convex prismatic polyhedron;
the prism cross section is an irregular and incomplete polygon such that the N sides are bounded by N+1 longitudinal fold edges, wherein a first edge and the (N+1)th edge are back edges that are spaced apart by a first separation GAP1; and the MCPCB board extends from at least one of the back edges inward toward a distal front side, thereby forming at least one interior wall that divides the structure into an open cavity flanked by at least one side cavity; and
at least the second through the Nth edges are in thermal contact with the glass jacket.

2. The lamp of claim 1 wherein:
back edges are spaced inward from the jacket inside diameter D1 by a second separation GAP2.

3. The lamp of claim 1 wherein:
the at least one interior wall is thermally attached to a distal front side, thereby additionally heat sinking the front side.

4. The lamp of claim 3 further comprising:
LEDs mounted only on one or two front sides;
thereby providing directed light output with a beam spread substantially determined by the angles at the edges of the one or two front sides.

5. The lamp of claim 1 wherein:
in an unbiased neutral state, the LED carrier edges are circumscribed by a circle of diameter D2′ that is greater than the jacket inside diameter D1, and the metal board is resilient with a spring bias toward the neutral state, such that the module is in a constricted state when inside the jacket, thereby biasing the fold edges into thermal contact with the jacket wall, and providing friction to hold the LED module in a predetermined longitudinal position within the jacket.

6. The lamp of claim 1 further comprising:
a wool-like porous and highly interconnected lightweight material having thermal conductivity greater than about 10 W/mK, substantially filling one or more of the center and side cavities, and thermally contacting the MCPCB walls therearound.

7. The lamp of claim 1 wherein:
the LED carrier is a metal printed circuit board (MCPCB) comprising:
a polyimide dielectric layer, and copper traces without a solder mask layer;
thereby enabling MCPCB bending without surface cracking, and minimizing potential VOC emissions.

8. The lamp of claim 7 further comprising:
an AC LED driver circuit mounted on at least one carrier side that is separate from any side that is an LED mounting face

9. The lamp of claim 7 further comprising:
AC LED driver circuit mounted on at least one of the at least one interior walls.

10. The lamp of claim 1 further comprising:
a lamp base adhered over an open end of the jacket.

11. The lamp of claim 10 wherein:
the base is plastic.

12. The lamp of claim 10 wherein:
the base has thermal conductivity greater than 1 W/mK.

13. The lamp of claim 12 wherein:
the LED carrier extends into thermal contact with the base.

14. The lamp of claim 10 wherein:
the base comprises a watertight seal for the lamp wherein vent openings are sealed or covered by a methyl silicone breathable membrane or adhesive or sealant, thereby allowing egress of volatile materials while blocking liquid water.

15. The lamp of claim 10 further comprising:
a desiccant material inside the jacket.

16. The lamp of claim 10 further comprising:
one or a combination of getters for capturing volatile materials, wherein the getters are selected from a group that includes: active carbon, natural zeolite, de-aluminized zeolite, surface treated zeolite, and silica.

17. The lamp of claim 10 wherein:
the base is at least partly made from a porous ceramic having a pores too small to allow passage of liquid water.

18. The lamp of claim 17 wherein:
the porous ceramic is etched polycrystalline alumina.
